(19) United States
(12) Patent Application Publication
(10) Pub. No.: US 2025/0369783 A1
(43) Pub. Date: Dec. 4, 2025

(54) COMPOSITE SENSOR

(71) Applicant: Murata Manufacturing Co., Ltd., Nagaokakyo-shi (JP)

(72) Inventors: Hiroshi WATANABE, Nagaokakyo-shi (JP); Koichi INOUE, Nagaokakyo-shi (JP); Takatoshi KATO, Nagaokakyo-shi (JP)

(21) Appl. No.: 19/299,672

(22) Filed: Aug. 14, 2025

Related U.S. Application Data
(63) Continuation of application No. PCT/JP2024/001883, filed on Jan. 23, 2024.

(30) Foreign Application Priority Data
Mar. 20, 2023 (JP) 2023-044176

(51) Int. Cl. G01D 21/02; G01C 3/06; G01L 1/24

(52) U.S. Cl. CPC G01D 21/02; G01C 3/06; G01L 1/24

(57) ABSTRACT

A composite sensor includes a substrate including first and second surfaces facing in opposite directions, an optical proximity sensor including a first light emitter and a first light receiver on the first surface of the substrate to output a signal dependent on a distance to an object by receiving, at the first light receiver, light emitted from the first light emitter and reflected by the object, a force sensor on the second surface of the substrate to output a signal dependent on a component of force that is perpendicular or substantially perpendicular to the substrate, a processor configured or programmed to process the signal from the optical proximity sensor and the signal from the force sensor and calculate information on the distance to the object and information on force received from the object.

### CROSS REFERENCE TO RELATED APPLICATIONS

This application claims the benefit of priority to Japanese Patent Application No. 2023-044176 filed on Mar. 20, 2023 and is a Continuation Application of PCT Application No. PCT/JP2024/001883 filed on Jan. 23, 2024. The entire contents of each application are hereby incorporated herein by reference.

### BACKGROUND OF THE INVENTION

### 1. Field of the Invention

The present invention relates to composite sensors.

### 2. Description of the Related Art

For example, for next-generation game controllers, there is a demand for the development of sensors that can continuously acquire proximity information and pressure information to obtain information on finger motions and detailed actions without being affected by hand size and other factors. A composite sensor is known which combines a proximity sensor for measuring the distance to an object and a force sensor for detecting an applied force (see, for example, Japanese Unexamined Patent Application Publication No. 2019-39835 and International Publication No. 2020/017177).

The composite sensor disclosed in Japanese Unexamined Patent Application Publication No. 2019-39835 includes a distance measurement sensor mounted on the front side of a substrate, and a pressure measurement sensor and a contact detection sensor mounted on the back side. The distance measurement sensor calculates the distance by measuring the time interval between transmission and reception of ultrasound waves. The pressure measurement sensor detects a change in electrostatic capacitance caused by membrane deformation and calculates pressure from the change in electrostatic capacitance. The contact detection sensor is designed to have a larger membrane deformation than the pressure measurement sensor and detects contact with high sensitivity.

The composite sensor disclosed in International Publication No. 2020/017177 includes a light-emitting unit, a light-receiving unit, and a dome-shaped elastic portion that covers the light-emitting unit and the light-receiving unit. Light emitted from the light-emitting unit is transmitted through the elastic portion and guided to the outside, and light reflected by an object is transmitted through the elastic portion and received by the light-receiving unit. The elastic portion is partially provided with a mirror, and light emitted from the light-emitting unit and reflected by the mirror is received by the light-receiving unit. When the elastic portion deforms, the amount of reflected light received from the mirror disposed on the elastic portion changes. From this change, a force applied to the elastic portion is calculated. The distance to the object is calculated based on light reception information on light transmitted through the elastic portion, reflected by the object, and received by the light-receiving unit.

In the composite sensor disclosed in Japanese Unexamined Patent Application Publication No. 2019-39835, the distance measurement sensor uses ultrasound waves. When an object approaches the distance measurement sensor, it is difficult to measure the distance due to the effect of reverberation time. Contact with the object is detected by the contact detection sensor, but when the distance to the object is between a certain proximity distance and contact (zero distance), the distance to the object cannot be measured. In other words, when the object approaches, it is difficult to continuously measure the distance during the period from the proximity state to contact.

In the composite sensor disclosed in International Publication No. 2020/017177, the light-emitting unit and the light-receiving unit are shared for measuring distance and force. This makes it difficult to independently design a sensor for distance measurement and a sensor for force measurement.

### SUMMARY OF THE INVENTION

Example embodiments of the present invention provide composite sensors that each perform measurement of distance to an object and measurement of force after contact in a substantially continuous manner, while allowing a sensor for distance measurement and a sensor for force measurement to be independently and suitably designed.

An example embodiment of the present invention provides a composite sensor including a substrate including a first surface and a second surface facing in opposite directions, an optical proximity sensor including a first light emitter and a first light receiver on the first surface of the substrate to output a signal dependent on a distance to an object by receiving, at the first light receiver, light emitted from the first light emitter and reflected by the object, a force sensor on the second surface of the substrate to output a signal dependent on a component of force that is perpendicular or substantially perpendicular to the substrate, and a processor configured or programmed to process the signal from the optical proximity sensor and the signal from the force sensor, and calculate information on the distance to the object and information on force received from the object.

In each of the example embodiments of the present invention, since the optical proximity sensor is used to measure the distance, reverberation effects, such as those produced by an ultrasound sensor, are not produced. Therefore, it is possible to eliminate difficulties in measurement caused by reverberation effects produced when an object approaches the sensor. Additionally, since the optical proximity sensor and the force sensor are disposed on the first surface and the second surface of the substrate, respectively, the optical proximity sensor and the force sensor are able to be designed more independently than with a configuration in which the optical proximity sensor and the force sensor share the light receivers and the light emitters.

The above and other elements, features, steps, characteristics and advantages of the present invention will become more apparent from the following detailed description of the example embodiments with reference to the attached drawings.

### BRIEF DESCRIPTION OF THE DRAWINGS

FIGS. 1A and 1B are a schematic perspective view and a schematic side view, respectively, of a composite sensor according to a first example embodiment of the present invention.

FIG. 2 is a schematic cross-sectional view of the composite sensor according to a first example embodiment of the present invention focusing on an optical proximity sensor.

FIG. 3 is a graph showing an example of measured values of distance and force when an object gradually approaches the composite sensor according to a first example embodiment of the present invention, comes into contact with a cover, and then applies a force to the cover.

FIG. 4A is a schematic cross-sectional view of a composite sensor according to a second example embodiment of the present invention, and FIG. 4B is a schematic cross-sectional view of the composite sensor, with an elastic portion elastically deformed.

FIG. 5 is a diagram illustrating a positional relationship of components when a first surface or a second surface of a substrate is viewed in plan view.

FIG. 6 is a block diagram illustrating a processor of the composite sensor according to the second example embodiment of the present invention.

FIG. 7 is a schematic cross-sectional view of a composite sensor according to a third example embodiment of the present invention.

FIG. 8 is a schematic cross-sectional view of a composite sensor according to a modification of the third example embodiment of the present invention.

FIG. 9A is a schematic perspective view of a substrate of a composite sensor according to a fourth example embodiment of the present invention, and first light emitters and a first light receiver of an optical proximity sensor, and FIG. 9B is a diagram illustrating an exemplary positional relation of four first light emitters and one first light receiver in plan view.

FIG. 10 is a diagram illustrating a positional relationship of one first light emitter, one first light receiver, and an object, as well as a coordinate system.

FIG. 11 is a diagram illustrating a planar positional relationship of first light emitters and a first light receiver of a composite sensor according to a modification of the fourth example embodiment of the present invention.

FIG. 12 is a graph showing an example of a signal output by a composite sensor according to a fifth example embodiment of the present invention.

### DETAILED DESCRIPTION OF THE EXAMPLE EMBODIMENTS

Example embodiments of the present invention will be described in detail below with reference to the drawings.

### First Example Embodiment

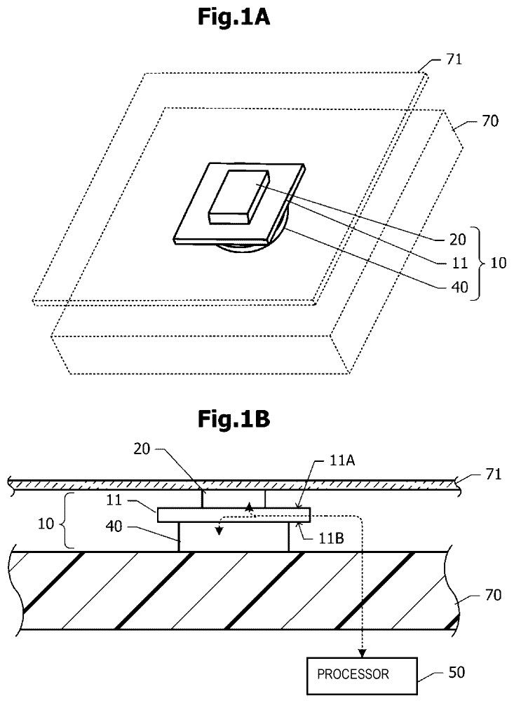

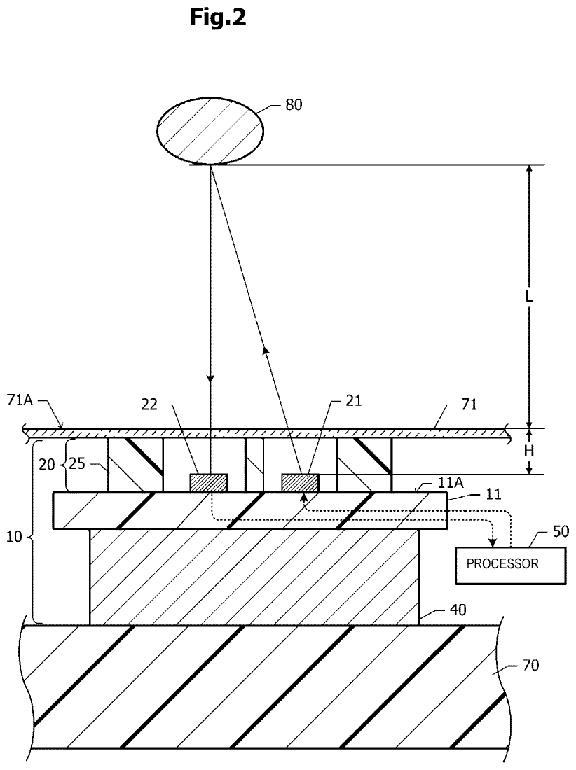

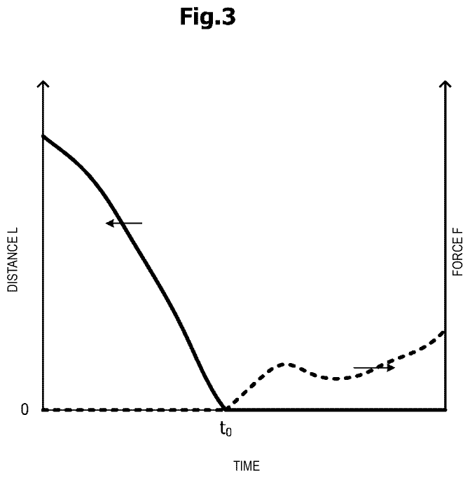

A composite sensor according to a first example embodiment of the present invention will be described with reference to FIG. 1A, FIG. 1B, FIG. 2, and FIG. 3.

FIG. 1A and FIG. 1B are a schematic perspective view and a schematic side view, respectively, of a composite sensor 10 according to the first example embodiment. The composite sensor 10 according to the first example embodiment includes a substrate 11, an optical proximity sensor 20, and a force sensor 40. The optical proximity sensor 20 is disposed on one side of the substrate 11 (hereinafter referred to as a first surface 11A) and the force sensor 40 is disposed on the other side of the substrate 11 (hereinafter referred to as a second surface 11B) facing in a direction opposite the first surface 11A.

A multilayer wiring board, such as a printed wiring board or a low-temperature co-fired ceramic (LTCC) board, for example, is used as the substrate 11. The substrate 11 includes wires connected to the optical proximity sensor 20 and the force sensor 40.

The force sensor 40 is secured to a housing 70 of a device, such as a game controller, for example, while a surface thereof facing in the same direction as the second surface 11B is in contact with the housing. The housing 70 is made of a thermoplastic material commonly used, for example, in housings of home electric appliances. A surface of the optical proximity sensor 20 facing in the same direction as the first surface 11A is in contact with a cover 71 of the device. The cover 71 is transparent in the wavelength region of light used by the optical proximity sensor 20.

The optical proximity sensor 20 emits light to measure to the outside through the cover 71 under the control of the processor 50. Light reflected by an object passes through the cover 71 and is received by the optical proximity sensor 20. A signal including light reception information is sent to the processor 50. The processor 50 calculates the distance to the object based on the light reception information. The processor 50 is mounted, for example, on the substrate 11.

When a force is applied to the cover 71, the force applied to the cover 71 is applied to the housing 70 via the optical proximity sensor 20, the substrate 11, and the force sensor 40. The force sensor 40 receives a reactive force from the housing 70 and measures the magnitude of the reactive force. That is, the force sensor sends, to the processor 50, a signal that depends on a component of force that is perpendicular or substantially perpendicular to the substrate 11. The processor 50 calculates the magnitude of the force applied to the cover 71 based on the signal received from the force sensor 40. The force sensor 40 may have a function of measuring not only the component of force that is perpendicular or substantially perpendicular to the substrate 11, but also a component of force parallel or substantially parallel to the substrate 11 (shear force).

Various known sensors can be used as the force sensor 40. For example, a piezoelectric force sensor, an optical force sensor, or an electrostatic-capacitive force sensor can be used.

A configuration of the optical proximity sensor 20 will now be described with reference to FIG. 2. FIG. 2 is a schematic cross-sectional view of the composite sensor 10 focusing on the optical proximity sensor 20. The optical proximity sensor 20 includes a first light emitter 21 and a first light receiver 22 arranged on the first surface 11A of the substrate 11. As the first light emitter 21, for example, a light-emitting diode (LED) or a vertical-cavity surface-emitting laser (VCSEL) is used. As the first light receiver 22, for example, a photodiode, a phototransistor, or a CdS cell is used.

A spacer 25 is interposed between the cover 71 and the substrate 11. The spacer 25 keeps the space between the first surface 11A and the over 71 constant. A surface of the cover 71 facing outward is referred to as a measurement reference surface 71A. The measurement reference surface 71A is parallel or substantially parallel to the first surface 11A. The height from the light-receiving surface of the first light receiver 22 to the measurement reference surface 71A is denoted as H. The distance from the measurement reference surface 71A to the object 80, in the direction perpendicular or substantially perpendicular to the first surface 11A, is denoted as L.

Under the control of the processor 50, light to measure is emitted from the first light emitter 21. The light emitted from the first light emitter 21 is transmitted through the cover 71 to the outside of the device and reflected by the object 80. A portion of the light reflected from the object 80 is transmitted through the cover 71 and is received by the first light receiver 22. A signal including light reception information from the first light receiver 22 is supplied to the processor 50.

The processor 50 acquires the signal from the optical proximity sensor 20 and the signal from the force sensor 40 in a synchronized manner. Here, “acquiring in a synchronized manner” includes, for example, acquiring the two signals at the same time, acquiring the two signals at different times within a predetermined time difference, and acquiring one signal in response to the acquisition of the other signal.

The processor 50 outputs, in association with each other, data based on the signals from the optical proximity sensor 20 and the force sensor 40, which are acquired in a synchronized manner. For example, the data based on each of the two signals may be stored in the same packet and output. Alternatively, the data based on each of the two signals may be provided with a timestamp so that the two pieces of data are associated with each other via the timestamps.

The processor 50 may have the function of calculating the distance to the object 80 based on the light reception information. For example, when the reflectance of the object 80 is known, the processor 50 can calculate the distance to the object 80 based on the amount of light received. The composite sensor 10 is calibrated so that the result of calculation (measured value) of the distance L becomes zero when the object 80 comes into contact with the cover 71.

FIG. 3 is a graph showing an example of the measured value of the distance L and the measured value of the force F when the object 80 (FIG. 2) gradually approaches the composite sensor 10, comes into contact with the cover 71, and then applies the force F to the cover 71. The horizontal axis represents the elapsed time, the vertical axis on the left represents the distance L, and the vertical axis on the right represents the force F. In the graph, the solid line indicates the measured value of the distance L, and the broken line indicates the measured value of the force F.

As time passes, the object 80 (FIG. 2) approaches the composite sensor 10 and comes into contact with the cover 71 at time t₀. That is, the measured value of the distance L becomes zero. After time t₀, the measured value of the distance L is maintained at zero. During the period in which the measured value of the distance L is greater than zero (i.e., the period before time t₀), the measured value of the force F by the force sensor 40 is zero. After the object 80 contacts the cover 71, a force toward the housing 70 is applied from the object 80 (FIG. 2). This causes the measured value of the force F by the force sensor 40 to rise from zero and vary over time.

FIG. 3 illustrates an example in which the time when the measured value of the distance L by the optical proximity sensor 20 becomes zero coincides with the time when the measured value of the force F by the force sensor 40, but these times do not need to exactly coincide. For example, the measured value of the force F may rise before the measured value of the distance L becomes zero, or the measured value of the force F may rise after the measured value of the distance L becomes zero. The time when the measured value of the distance L becomes zero does not need to coincide with the time when the measured value of the force F becomes zero, as long as the gap between them is within an allowable range determined by an application that uses the output from the composite sensor 10.

It is preferable to calibrate the processor 50 in accordance with required specifications of the application so that the measured value of the force F by the force sensor 40 starts to rise when the measured value of the distance L based on the signal from the optical proximity sensor 20 becomes zero.

Advantageous effects of the first example embodiment will now be described.

In the first example embodiment, the optical proximity sensor 20 is used as a sensor that measures the distance to the object 80 (FIG. 2). Since the measurement is not affected by reverberation time or the like, as in the case of using an ultrasound sensor, the distance can be measured until the object 80 substantially comes into contact with the cover 71 (FIG. 2). When the object 80 contacts the cover 71, the force F is measured based on the signal from the force sensor 40. It is thus possible to substantially continuously (or seamlessly) measure the distance and force, starting from the state in which the object 80 is spaced away from the cover 71, through its approach to and contact with the cover 71, and up to the application of a force to the cover 71.

Since the processor 50 acquires the signal from the optical proximity sensor 20 and the signal from the force sensor 40 in a synchronized manner, the measured value of distance and the measured value of force corresponding to the same or substantially the same point in time can be determined from these signals. Additionally, since the processor 50 outputs, in association with each other, the data based on the signals from the optical proximity sensor 20 and the force sensor 40, which are acquired in a synchronized manner, an application that uses the composite sensor 10 can continuously transition on the time axis from a state in which the distance changes over time to a state in which the force changes over time, or vice versa.

In the first example embodiment, the optical proximity sensor 20 and the force sensor 40 can be independently designed, as long as the force applied to the cover 71 is transmitted via the optical proximity sensor 20 to the force sensor 40. Therefore, as compared to the configuration where the operations of the two sensors affect each other, it is easier to design the optical proximity sensor 20 and the force sensor 40 to satisfy their required specifications.

### Second Example Embodiment

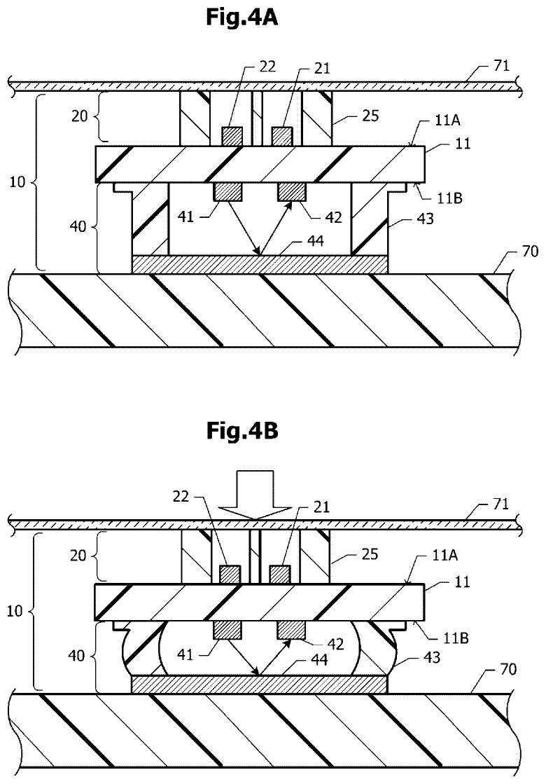

A composite sensor according to a second example embodiment of the present invention will now be described with reference to FIG. 4A to FIG. 7. The description of the components common to those of the composite sensor according to the first example embodiment, described with reference to FIG. 1A to FIG. 3, will be omitted.

FIG. 4A is a schematic cross-sectional view of the composite sensor 10 according to the second example embodiment. The configuration of the optical proximity sensor 20 is the same or substantially the same as the configuration of the optical proximity sensor 20 of the composite sensor 10 according to the first example embodiment (FIG. 2). In the second example embodiment, an optical proximity sensor is also used for the force sensor 40. The force sensor 40 includes a second light emitter 41, a second light receiver 42, an elastic portion 43, and a reflector 44. As the second light emitter 41, for example, a light-emitting diode (LED) or a vertical-cavity surface-emitting laser (VCSEL) is used. As the second light receiver 42, for example, a photodiode, a phototransistor, or a CdS cell is used.

The second light emitter 41 and the second light receiver 42 are arranged on the second surface 11B of the substrate 11. The reflector 44 is disposed at a distance from the second surface 11B. The reflector 44 is supported by the substrate 11, with the elastic portion 43 interposed therebetween.

The reflector 44 is in contact with the housing 70. The Young's modulus of the elastic portion 43 is lower than the Young's modulus of any of the housing 70, the substrate 11, and the spacer 25. When a force is applied to the cover 71, the elastic portion 43 is elastically deformed. For example, the Young's modulus (flexural modulus) of the elastic portion 43 is less than about 1000 MPa.

FIG. 4B is a schematic cross-sectional view of the composite sensor 10, with the elastic portion 43 elastically deformed. The elastic deformation of the elastic portion 43 changes the position of the reflector 44 relative to the second light emitter 41 and the second light receiver 42. For example, the reflector 44 approaches the second light emitter 41 and the second light receiver 42. The amount of change in relative position depends on the magnitude of the force applied.

Light emitted from the second light emitter 41 is reflected by the reflector 44 and a portion of the reflected light is received by the second light receiver 42. When the position of the reflector 44 relative to the second light emitter 41 and the second light receiver 42 changes, light reception information from the second light receiver 42, such as the amount of received light, changes. A signal including the light reception information from the second light receiver 42 is supplied to the processor 50 (FIG. 1B). The processor 50 calculates the amount of displacement of the reflector 44 based on the light reception information from the second light receiver 42, and calculates the magnitude of applied force from the amount of displacement.

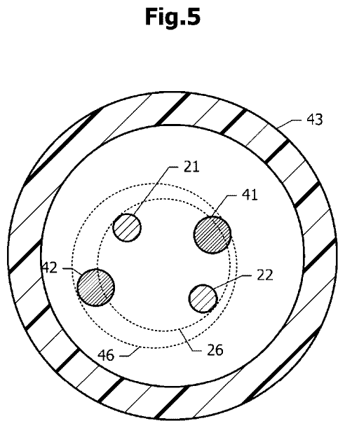

FIG. 5 is a diagram illustrating a positional relationship of components when the first surface 11A or the second surface 11B of the substrate 11 (FIG. 4A) is viewed in plan view (hereinafter simply referred to as “in plan view”). The elastic portion 43 is disposed around the second light emitter 41 and the second light receiver 42. The elastic portion 43 has, for example, an annular shape.

A minimum enclosing circle 26 that includes the first light emitter 21 and the first light receiver 22 of the optical proximity sensor 20 and a minimum enclosing circle 46 that includes the second light emitter 41 and the second light receiver 42 of the force sensor 40 include an overlapping portion. The composite sensor 10 has a structure in which the force sensor 40 and the optical proximity sensor 20 are stacked in the thickness direction of the substrate 11. Although the minimum enclosing circle 26 including the first light emitter 21 and the first light receiver 22 is smaller than the minimum enclosing circle 46 including the second light emitter 41 and the second light receiver 42 in the example illustrated in FIG. 5, the size relationship between them may be reversed. A portion of the minimum enclosing circle 26 may overlap with a portion of the minimum enclosing circle 46.

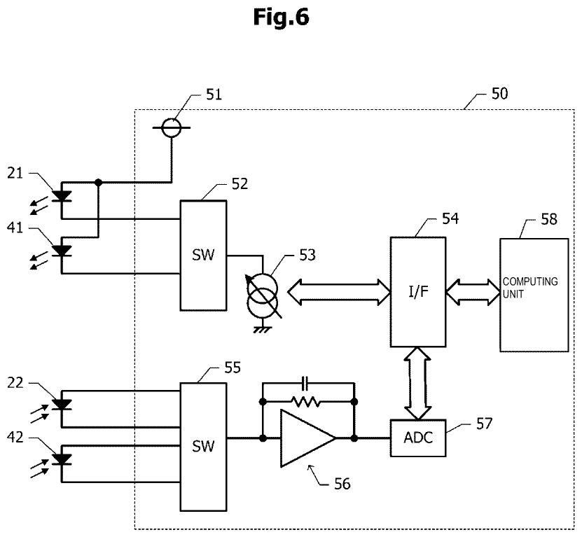

FIG. 6 is a block diagram illustrating the processor 50 of the composite sensor 10 according to the second example embodiment. The anodes of the first light emitter 21 and the second light emitter 41 are connected to a power supply 51, and their cathodes are connected via a switch matrix 52 to a light receiver driver 53. A computer 58 controls the light receiver driver 53 and the switch matrix 52 via an interface 54. When the switch matrix 52 selects one of the first light emitter 21 and the second light emitter 41, the selected light emitter emits light.

The first light receiver 22 and the second light receiver 42 are connected to a switch matrix 55. The computer 58 controls the switch matrix 55 via the interface 54. When the switch matrix 55 selects one of the first light receiver 22 and the second light receiver 42, a current generated in accordance with the amount of light received in the selected light receiver is supplied via the switch matrix 55 to a transimpedance amplifier 56.

The current output from the first light receiver 22 or the second light receiver 42 is converted by the transimpedance amplifier 56 to a voltage signal, which is then supplied to an AD converter 57. The voltage signal is converted by the AD converter 57 to a digital signal, which is then supplied via the interface unit 54 to the computer 58.

The computer 58 causes the first light emitter 21 and the second light emitter 41 to alternately emit light. When the first light emitter 21 emits light, the computer 58 acquires light reception information from the first light receiver 22, and when the second light emitter 41 emits light, the computer 58 acquires light reception information from the second light receiver 42. The computer 58 calculates the distance L to the object 80 (FIG. 2) based on the light reception information from the first light receiver 22, and calculates the magnitude of the force F applied to the cover 71 (FIG. 4B) based on the light reception information from the second light receiver 42. That is, the computer 58 alternately performs the calculation of the distance L and the calculation of the force F.

Advantageous effects of the second example embodiment will now be described.

In the second example embodiment, an optical proximity sensor the same as or similar to the optical proximity sensor 20 for distance measurement is also used for the force sensor 40. This allows an analog: front-end circuit including the light receiver driver 53, the transimpedance amplifier 56, and the AD converter 57 to be shared by the optical proximity sensor 20 and the force sensor 40.

Sharing the analog front-end circuit facilitates synchronization and timing control between the optical proximity sensor 20 and the force sensor 40. This facilitates seamless execution of distance measurement by the optical proximity sensor 20 and force measurement by the force sensor 40.

As illustrated in FIG. 5, the minimum enclosing circle 26 including the first light emitter 21 and the first light receiver 22 and the minimum enclosing circle 46 including the second light emitter 41 and the second light receiver 42 at least partially overlap in plan view. Therefore, the reference position for distance measurement and the reference position for force measurement are close to each other in the plane of the first surface 11A of the substrate 11 (FIG. 4A). Thus, since the gap between the proximity detection position and the contact detection position of the object 80 (FIG. 2) is reduced, detection results that are more natural to the user can be provided.

Since the Young's modulus of the elastic portion 43 of the force sensor 40 is smaller than those of the spacer 25, the substrate 11, and the housing 70 (FIG. 4A), the deformation caused by force applied to the cover 71 is localized substantially to the elastic portion 43. This enables the force sensor 40 to accurately measure the force applied to the cover 71. Moreover, as long as the stiffness of the elastic portion 43 of the force sensor 40 is lower than that of the spacer 25 of the optical proximity sensor 20, the design independence between the optical proximity sensor 20 and the force sensor 40 can be improved. Therefore, as compared to the configuration where the operations of the two sensors affect each other, it is easier to design the two sensors to meet the required specifications of the optical proximity sensor 20 and the force sensor 40.

A composite sensor according to a modification of the second example embodiment will now be described.

In the second example embodiment, the analog front-end circuit (FIG. 6) including the light receiver driver 53, the transimpedance amplifier 56, and the AD converter 57 is shared by the optical proximity sensor 20 and the force sensor 40. Alternatively, the optical proximity sensor 20 and the force sensor 40 may each include one analog front-end circuit. In this case, the optical proximity sensor 20 and the force sensor 40 can be operated at the same time. This can eliminate the gap in timing between the acquisition of distance information and the acquisition of force information when the object 80 contacts the cover 71 (FIG. 4A). Additionally, the time resolution of the measured value of distance and the measured value of force can be improved.

### Third Example Embodiment

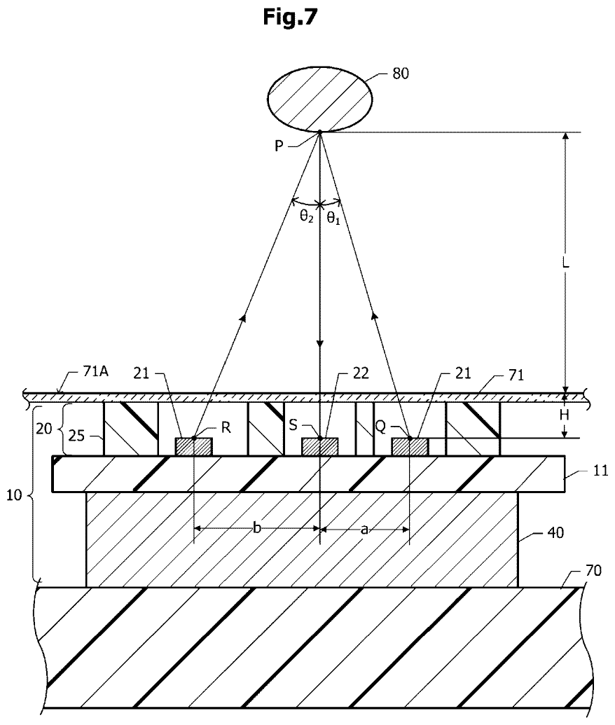

A composite sensor according to a third example embodiment of the present invention will now be described with reference to FIG. 7. The description of the components common to those of the composite sensor according to the first example embodiment, described with reference to FIG. 1A to FIG. 3, will be omitted.

FIG. 7 is a schematic cross-sectional view of the composite sensor 10 according to the third example embodiment. In the first example embodiment (FIG. 2), the optical proximity sensor 20 includes one first light emitter 21 and one first light receiver 22. In contrast, in the third example embodiment, the optical proximity sensor 20 includes two first light emitters 21 and one first light receiver 22. The optical proximity sensor 20 with such a configuration is disclosed, for example, in Japanese unexamined Patent Application Publication No. 57-133306. The principle of distance measurement using the optical proximity sensor 20 according to the third example embodiment will now be briefly described.

The two first light emitters 21 each emit light that spreads uniformly with high diffusivity. The center points of respective light-emitting portions of the two first light emitters 21 are denoted as Q and R. The first light receiver 22 has strong directivity in the direction normal to the first surface 11A. The center point of the light-receiving surface of the first light receiver 22 is denoted as S.

The two first light emitters 21 are driven by repetitive signals that are phase-shifted by about 90°. The object 80 is disposed on a straight line that extends perpendicularly or substantially perpendicularly to the first surface 11A from the point S. The point of intersection of the surface of the object 80 and the straight line that extends perpendicularly or substantially perpendicularly to the first surface 11A from the point S is denoted as P. An angle between a line segment PQ and a line segment PS is denoted as θ₁, and an angle between a line segment PR and the line segment PS is denoted as θ₂. The lengths of a line segment QS and a line segment RS are denoted as a and b, respectively.

Light emitted from each of the two first light emitters 21 is diffusely reflected at the point P on the surface of the object 80, and a portion of the diffusely reflected light is received by the first light receiver 22. The brightness of light emitted from each of the two first light emitters 21 can be considered to vary periodically in a sine and cosine wave pattern.

The length of the line segment PS can be calculated using the relationship between the phase of the intensity change of light emitted from the first light emitter 21 and the phase of the intensity change of light received by the first light receiver 22, the lengths a and b, and the angles θ₁ and θ₂. Equations for the calculation are described in Japanese unexamined Patent Application Publication No. 57-133306. Since the height H from the light-receiving surface of the first light receiver 22 to the measurement reference surface 71A is known, the distance L from the measurement reference surface 71A to the object 80 can be determined.

Advantageous effects of the third example embodiment will now be described.

In the third example embodiment, the distance L to the object 80 can be measured without depending on the reflectance of the surface of the object 80.

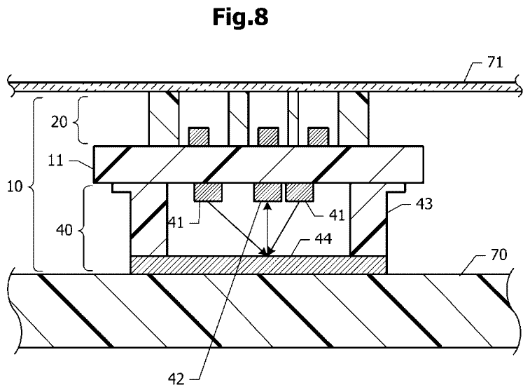

A modification of the third example embodiment will now be described with reference to FIG. 8.

FIG. 8 is a schematic cross-sectional view of the composite sensor 10 according to a modification of the third example embodiment. In the present modification, the force sensor 40 includes two second light emitters 41 and one second light receiver 42, similar to the optical proximity sensor 20. With this configuration, the distance from the second light receiver 42 to the reflector 44 can be measured without depending on the reflectance of the reflector 44.

### Fourth Example Embodiment

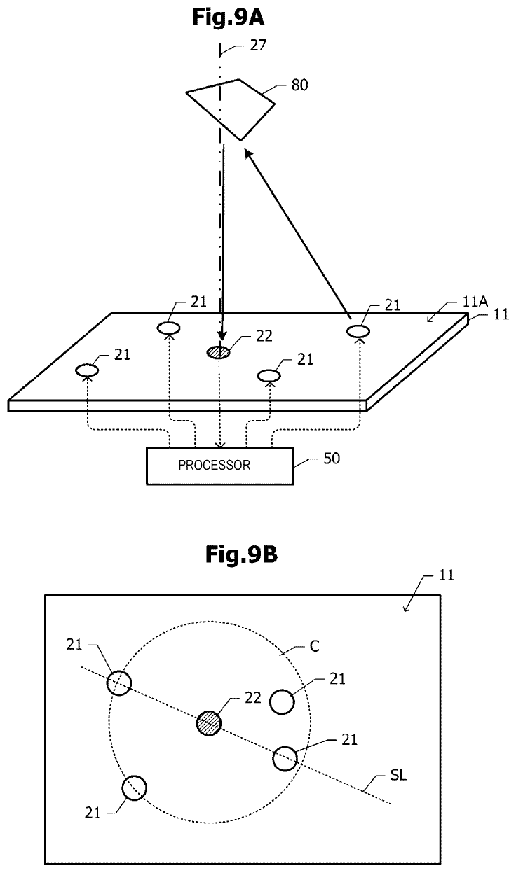

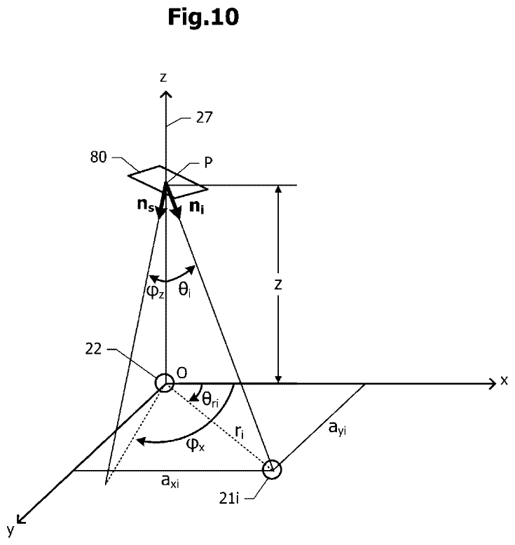

A composite sensor according to a fourth example embodiment of the present invention will now be described with reference to FIG. 9A, FIG. 9B, and FIG. 10. The description of the components common to those of the composite sensor according to the first example embodiment, described with reference to FIG. 1A to FIG. 3, will be omitted. The fourth example embodiment differs from the first example embodiment in the configuration of the optical proximity sensor 20.

FIG. 9A is a schematic perspective view of the substrate 11 of the composite sensor according to the fourth example embodiment, and the first light emitters 21 and the first light receiver 22 of the optical proximity sensor 20. In the fourth example embodiment, the optical proximity sensor 20 includes four first light emitters 21 and one first light receiver 22. In FIG. 9A, the first light emitters 21 are represented by hollow circles, and the first light receiver 22 is represented by a hatched circle.

The four first light emitters 21 and the one first light receiver 22 are arranged on a common virtual plane. For example, the four first light emitters 21 and the one first light receiver 22 are mounted on the flat first surface 11A of the substrate 11. The object 80 is located on a virtual straight line (hereinafter referred to as a reference axis 27) passing through the first light receiver 22 and extending in the direction normal to the first surface 11A. The distance from the first surface 11A to the object 80 and the posture of the object 80 are detected based on the intensity of light emitted from each of the first light emitters 21, reflected by the object 80, and incident on the first light receiver 22. Here, “passing through the first light receiver 22” means passing through the geometric center of the light-receiving region of the first light receiver 22.

FIG. 9B is a diagram illustrating an exemplary positional relationship of the four first light emitters 21 and the one first light receiver 22 in plan view. The four first light emitters 21 are not arranged on a single common straight line passing through the first light receiver 22, nor are they arranged on a single common circle centered on the first light receiver 22. That is, when a straight line SL is drawn passing through the first light receiver 22 and one first light emitter 21, at least one of the other three first light emitters 21 is spaced away from the straight line SL. In the example illustrated in FIG. 9B, two first light emitters 21 are spaced apart from the straight line SL. When a circle C is drawn centered on the first light receiver 22 and passing through one first light emitter 21, at least one of the other three first light emitters 21 is spaced away from the circle C. In the example illustrated in FIG. 9B, two first light emitters 21 are spaced away from the circle C.

The determination of whether each first light emitter 21 is located on the straight line SL or on the circle C is made based on the geometric center of the light-emitting region of the first light emitter 21. The determination of whether the first light receiver 22 is located on the straight line SL is made based on the geometric center of the light-receiving region of the first light receiver 22. The circle centered on the first light receiver 22 means a circle centered on the geometric center of the light-receiving region of the first light receiver 22. Because of this arrangement, the distance between at least one first light emitter 21 and the first light receiver 22 differs from the distances between the other three first light emitters 21 and the first light receiver 22. A total of four light-receiving and light-emitting pairs are defined by each of the four first light emitters 21 and the one first light receiver 22.

With reference to FIG. 10, the definition of a coordinate system and various parameters used in the description of the fourth example embodiment will be described. FIG. 10 is a diagram illustrating a positional relationship of one first light emitter 21i, one first light receiver 22, and the object 80, as well as a coordinate system. The xy-plane of the xyz rectangular coordinate system corresponds to the first surface 11A (FIG. 9A), and the first light receiver 22 is disposed at an origin O. The z-axis corresponds to the reference axis 27. A left-handed xyz rectangular coordinate system is used.

When consecutive numbers from 1 are assigned to the four first light emitters 21, the i-th first light emitter 21 is denoted as 21i. The x and y coordinates of the first light emitter 211 are denoted as aₓᵢ and a_{yi}, respectively. The distance from the origin O to the first light emitter 21i is denoted as rᵢ. The azimuth angle of the position of the first light emitter 21i with respect to the x-axis, which serves as a reference direction, is denoted as θᵣᵢ.

The point of intersection of the surface of the object 80 facing the origin O and the reference axis 27 (hereinafter referred to as the representative point of the object 80) is denoted as P. The distance from the origin O (first light receiver 22) to the representative point P of the object 80 is denoted as z. In the description of the fourth example embodiment, the distance z from the first light receiver 22 to the representative point P of the object 80 may simply be referred to as the distance Z from the first light receiver 22 to the object 80. The unit vector from the representative point P of the object 80 toward the first light emitter 21i is denoted as nᵢ. The angle between the unit vector nᵢ and the reference axis 27 is denoted as θᵢ.

The unit normal vector of the surface of the object 80 at the position of the representative point P is denoted as nₛ. The angle between the unit normal vector nₛ and the reference axis 27 is denoted as φ_{z}. The angle φ_{z} is referred to as the tilt angle of the object 80. The angle between by the vertical projection of the unit normal vector nₛ onto the xy-plane and the x-axis is denoted as φₓ. The angle φₓ is referred to as the tilt azimuth angle of the surface of the object 80.

Directional characteristics of the first light emitter 21 and the first light receiver 22 will now be described.

In the first light emitter 21, the light intensity is maximum in the front direction, and decreases as the tilt angle θ from the front direction increases. The tilt angle θ at which the light intensity is about half that in the front direction is referred to as the half angle at half maximum θ_{1/2}. In the first light receiver 22, the light-receiving sensitivity is maximum in the front direction, and decreases as the tilt angle e increases. The tilt angle θ at which the light-receiving sensitivity is about half that in the front direction is referred to as the half angle at half maximum θ_{1/2}.

The first light emitter 21 has a wider directional characteristic than the first light receiver 22. For example, the first light emitter 21 has a directional characteristic that is wide enough to irradiate the object 80 (FIG. 9A) located on the reference axis 27 with light of sufficient intensity. The first light receiver 22 has a sharp directional characteristic that can exhibit sufficiently low sensitivity to light reflected from an object located significantly off the reference axis 27. For example, the half angle at half maximum θ_{1/2} of the directional characteristic of the first light receiver 22 is preferably less than or equal to about 15°, more preferably less than or equal to about 10°, and most preferably less than or equal to about 5°.

When the directional characteristic of the first light emitter 21 is not dependent on the azimuth angle, the directional characteristic LD (θ) of the first light emitter 21 can generally be approximated by the following equation.

$$\begin{matrix}Equation l & \\ LD ( θ ) = {cos}^{n} θ & ( 1 )\end{matrix}$$

Here, n is a parameter determined by the directional characteristic of the first light emitter 21. The greater the value of n, the sharper the directional characteristic.

The emission intensity of the i-th first light emitter 21i in the front direction is denoted as Gᵢ, and the light-receiving sensitivity of the first light receiver 22 is denoted as C. The reflectance of the surface of the object 80 is denoted as α. A light intensity LIi at the representative point P is expressed by the following equation. The four first light emitters 21 have the same or substantially the same directional characteristic LD (θ).

$$\begin{matrix}Equation 2 & \\ LIi = {cos}^{n} {θ}_{i} = {( \frac{z}{\sqrt{{r}_{i}^{2} + {z}^{2}}} )}^{n} & ( 2 )\end{matrix}$$

The intensity of light detected by the first light receiver 22, that is, the luminance Li of the representative point P when the representative point P is viewed from the first light receiver 22 as a new light source, is expressed by the following equation.

$$\begin{matrix}Equation 3 & \\ Li = \frac{C α {G}_{ì}}{{z}^{β}} {( \frac{z}{\sqrt{{r}_{i}^{2} + {z}^{2}}} )}^{n} \cdot \frac{[ \frac{{r}_{\dot{t}} sin {φ}_{z}}{cos {φ}_{z}} cos ( {θ}_{r ì} - {φ}_{x} ) + z ]}{{( {r}_{i}^{2} + {z}^{2} )}^{\frac{3}{2}}} & ( 3 )\end{matrix}$$

The term z^{β} in the denominator on the right side of equation (3) indicates that when the field of view of the first light receiver 22 widens as the distance z increases, the contribution of the luminance per unit area of the surface of the object 80 (FIG. 1A) decreases. When a wide region of the surface of the object 80 is irradiated with light and the surface of the object 80 is greater than the field of view of the first light receiver 22, the light will be received over the entire or substantially the entire field of view of the first light receiver 22 even when the distance z increases. The influence of the term z^{β} decreases in this case. Depending on the shape and size of the object 80 and the magnitude of the half angle at half maximum θ_{1/2} of the directional characteristic of the first light receiver 22, β in equation (3) will actually take any value in the range greater than or equal to about 0 and less than or equal to about 2.

Since the parameter CαGᵢ/z^{β} on the right side of equation (3) is common to the four first light emitters 21, there are four unknowns, the parameter CαGⁱ/z^{β}, the distance z, the tilt azimuth angle φₓ, and the tilt angle φ_{z}, in equation (3) and four equations (3) for i=1, 2, 3, and 4 are generated. Since the four first light emitters 21 are not arranged on a single common straight line passing through the first light receiver 22, nor are they arranged on a single common circle centered on the first light receiver 22, the four equations linearly independent. Therefore, the processor 50 can determine the parameter CαGᵢ/z^{β}, the distance z, the tilt azimuth angle φₓ, and the tilt angle φ_{z} by solving the system of four simultaneous equations.

Advantageous effects of the fourth example embodiment will now be described.

In the fourth example embodiment, the distance z, the tilt azimuth angle φₓ, and the tilt angle φ_{z} can be determined using four first light emitters 21 and one first light receiver 22. That is, in addition to the distance to the object 80, the azimuth and angle at which the surface of the object 80 tilts can be determined.

In the composite sensor according to the fourth example embodiment, the directional characteristic LD (θ) of the four first light emitters 21 is not dependent on the azimuth angle and is isotropic, but does not necessarily need to be isotropic. For example, if the directional characteristic can be transformed by coordinate transformation into a form that is not dependent on the azimuth angle, the directional characteristic does not necessarily need to be isotropic.

For example, if the half angle at half maximum θ_{1/2} in the xz-plane illustrated in FIG. 10 is about twice the half angle at half maximum θ_{1/2} in the yz-plane, doubling the value on the y-axis makes the half angle at half maximum θ_{1/2} in the xz-plane equal to the half angle at half maximum θ_{1/2} in the yz-plane, which is equivalent to the case where the directional characteristic is not dependent on the azimuth angle. Therefore, by performing coordinate transformation, a system of simultaneous equations in the same form as equation (3) can be obtained.

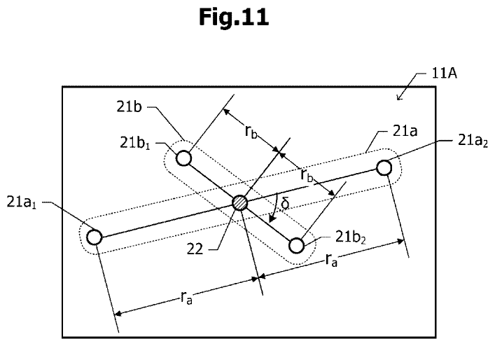

With reference to FIG. 11, a composite sensor according to a modification of the fourth example embodiment will be described.

FIG. 11 is a diagram illustrating a planar positional relationship of the first light emitters 21 and the first light receiver 22 of a composite sensor according to a modification of the fourth example embodiment.

In the fourth example embodiment (FIG. 9B), no three of the four first light emitters 21 are arranged on a single straight line, and the four first light emitters 21 are not arranged on a common circle centered on the first light receiver 22. In the present modification, the four first light emitters 21 are arranged so as to satisfy, in addition to these conditions, the conditions described below.

In the present modification, two first light emitters 21a₁ and 21a₂ of the four first light emitters 21 are point-symmetrically arranged with respect to the first light receiver 22, and the other two first light emitters 21b₁ and 21b₂ are also point-symmetrically arranged with respect to the first light receiver 22. The distance from the first light receiver 22 to each of the first light emitters 21a₁ and 21a₂ is denoted as rₐ, and the distance from the first light receiver 22 to each of the first light emitters 21b₁ and 21b₂ is denoted as r_{b}. An angle between the straight line passing through the two first light emitters 21a₁ and 21a₂ and the straight line passing through the two first light emitters 21b₁ and 21b₂ is denoted as δ. The angle o is greater than about 0° and less than about 180°.

Two first light emitters 21 point-symmetrically arranged are referred to as a first light emitter pair. In the present modification, the two first light emitters 21a₁ and 21a₂ define one first light emitter pair 21a, and the other two first light emitters 21b₁ and 21b₂ define the other first light emitter pair 21b.

Applying equation (3) to the first light emitter 21a₁ yields the following equation.

$$\begin{matrix}Equation 4 & \\ {L}_{a 1} = \frac{C α {G}_{a 1}}{{z}^{β}} {( \frac{z}{\sqrt{{r}_{a}^{2} + {z}^{2}}} )}^{𝔫} \cdot \frac{[ \frac{{r}_{a} sin {φ}_{z}}{cos {φ}_{z}} cos ( {θ}_{ra 1} - {φ}_{x} ) + z ]}{{( {r}_{a}^{2} + {z}^{2} )}^{\frac{3}{2}}} & ( 4 )\end{matrix}$$

Applying equation (3) to the first light emitter 21a₂ yields the following equation.

$$\begin{matrix}Equation 5 & \\ {L}_{a 2} = \frac{C α {G}_{a 2}}{{z}^{β}} {( \frac{z}{\sqrt{{r}_{a}^{2} + {z}^{2}}} )}^{n} \cdot \frac{[ \frac{{r}_{a} sin {φ}_{z}}{cos {φ}_{z}} cos ( {θ}_{ra 2} - {φ}_{x} ) + z ]}{{( {r}_{a}^{2} + {z}^{2} )}^{\frac{3}{2}}} & ( 5 )\end{matrix}$$

Since Ga₁=Ga₂ and θra₁+θra₂=180° in equation (4) and equation (5), the following equation is obtained from equation (4) and equation (5).

$$\begin{matrix}Equation 6 & \\ {L}_{a 1} + {L}_{a 2} = 2 \frac{C α {C}_{a 1}}{{z}^{β}} {( \frac{z}{\sqrt{{r}_{a}^{2} + {z}^{2}}} )}^{n} \cdot \frac{1}{{( {r}_{a}^{2} + {z}^{2} )}^{\frac{3}{2}}} & ( 6 )\end{matrix}$$

Similarly, the following equation is obtained for the first light emitters 21b₁ and 21b₂.

$$\begin{matrix}Equation 7 & \\ {L}_{b 1} + {L}_{b 2} = 2 \frac{C α {G}_{a 1}}{{z}^{β}} {( \frac{z}{\sqrt{{r}_{b}^{2} + {z}^{2}}} )}^{n} \cdot \frac{1}{{( {r}_{b}^{2} + {z}^{2} )}^{\frac{3}{2}}} & ( 7 )\end{matrix}$$

A ratio R between the sum of measured values obtained when light is emitted by each of the first light emitters 21a₁ and 21a₂, defining the first light emitter pair 21a, and received by the first light receiver 22, and the sum of measured values obtained when light is emitted by each of the first light emitters 21b₁ and 21b₂, defining the first light emitter pair 21b, and received by the first light receiver 22, is expressed by the following equation using equation (6) and equation (7).

$$\begin{matrix}Equation 8 & \\ R = \frac{{L}_{b 1} + {L}_{b 2}}{{L}_{a 1} + {L}_{a 2}} = \frac{{( {r}_{a}^{2} + {z}^{2} )}^{\frac{n + 3}{2}}}{{( {r}_{b}^{2} + {z}^{2} )}^{\frac{n + 3}{2}}} & ( 8 )\end{matrix}$$

Since the unknown in equation (8) is z alone, the distance Z to the object 80 can be calculated from the ratio R.

Additionally, the following equation is obtained for the first light emitter pair 21a from equation (4) and equation (5).

$$\begin{matrix}Equation 9 & \\ {L}_{a 1} - {L}_{a 2} = 2 \frac{C α {G}_{a 1}}{{z}^{β}} {( \frac{z}{\sqrt{{r}_{a}^{2} + {z}^{2}}} )}^{n} \cdot \frac{[ \frac{{r}_{a} sin {φ}_{z}}{cos {φ}_{z}} cos ( {θ}_{ra 1} - {φ}_{x} ) ]}{{( {r}_{a}^{2} + {z}^{2} )}^{\frac{3}{2}}} = ( {L}_{a 1} + {L}_{a 2} ) \frac{{r}_{a}}{z} tan {φ}_{z} cos ( {θ}_{r a 1} - {φ}_{x} ) & ( 9 )\end{matrix}$$

Similarly, the following equation is obtained for the first light emitter pair 21b.

$$\begin{matrix}Equation 10 & \\ {L}_{b 1} - {L}_{b 2} = 2 \frac{C α {G}_{a 1}}{{z}^{β}} {( \frac{z}{\sqrt{{r}_{b}^{2} + {z}^{2}}} )}^{n} \cdot \frac{[ \frac{{r}_{b} sin {φ}_{z}}{cos {φ}_{z}} cos ( {θ}_{rb 1} - {φ}_{x} ) ]}{{( {r}_{b}^{2} + {z}^{2} )}^{\frac{3}{2}}} = ( {L}_{b 1} + {L}_{b 2} ) \frac{{r}_{b}}{z} tan {φ}_{z} cos ( {θ}_{rb 1} - {φ}_{x} ) & ( 10 )\end{matrix}$$

The following equation is derived from equation (9) and equation (10).

$$\begin{matrix}Equation 11 & \\ {L}_{b 1} - {L}_{b 2} = \frac{1}{R} ( {L}_{a 1} - {L}_{a 2} ) cos δ - \frac{1}{R} \sqrt{{A}_{1}^{2} - {( {L}_{a 1} - {L}_{a 2} )}^{2}} sin δ & ( 11 )\end{matrix}$$

Here, the parameter R is defined by equation (8), and a parameter A₁ is defined by the following equation.

$$\begin{matrix}Equation 12 & \\ {A}_{1} = ( {L}_{a 1} + {L}_{a 2} ) \frac{{r}_{a}}{z} tan {φ}_{z} & ( 12 )\end{matrix}$$

The value of the parameter A₁ can be calculated from equation (11). Once the value of the parameter A₁ is known, the tilt angle φ_{z} can be calculated from equation (12). Moreover, the tilt azimuth angle φₓ can be calculated from equation (9). Thus, the tilt angle φ_{z} and the tilt azimuth angle φₓ can be calculated by determining the sum and difference of the measured values from the two first light emitter pairs 21a and 21b and performing simple algebraic calculations.

Advantageous effects of the modification of the fourth example embodiment, illustrated in FIG. 11, will now be described.

In the modification of the fourth example embodiment, the distance Z to the object 80 and the tilt angle φ_{z} and the tilt azimuth angle φₓ of the surface of the object 80 can be determined by performing simple algebraic calculations, without solving a system of four simultaneous equations.

### Fifth Example Embodiment

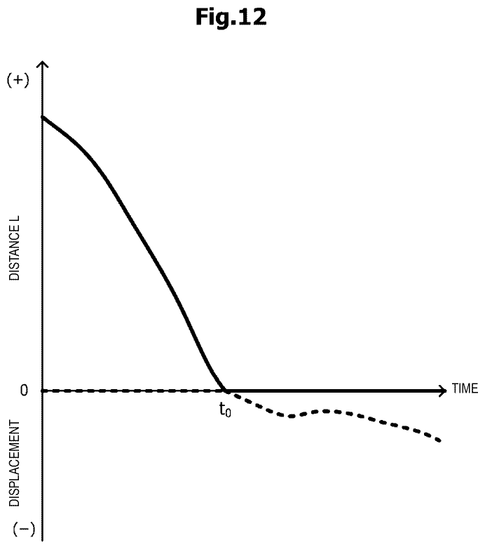

A composite sensor according to a fifth example embodiment of the present invention will now be described with reference to FIG. 12. The description of the components common to those of the composite sensors according to the first and second example embodiments, described with reference to FIG. 1A to FIG. 6, will be omitted.

FIG. 12 is a graph showing an example of a signal output by a composite sensor according to the fifth example embodiment. As illustrated as an example in FIG. 3, the composite sensor 10 according to the first example embodiment outputs a measured value of the distance L determined based on a signal from the optical proximity sensor 20 and a measured value of the force F determined based on a signal from the force sensor 40.

In contrast, the composite sensor 10 according to the fifth example embodiment determines the amount of displacement of the reflector 44 with respect to the second light emitter 41 and the second light receiver 42, illustrated in FIG. 4A, based on the signal from the force sensor 40. The amount of displacement when no external force is applied to the force sensor 40 is defined as zero. When an external force is applied to the force sensor 40, the reflector 44 is displaced in the direction toward the second light emitter 41 and the second light receiver 42. The amount of displacement in this direction is defined as negative. The magnitude of the displacement varies in accordance with the magnitude of force applied to the composite sensor 10. In FIG. 12, a broken line indicates how the amount of displacement changes over time.

As illustrated in FIG. 12, after the object 80 (FIG. 2) is gradually brought closer to the composite sensor 10 and the distance L measured by the optical proximity sensor 20 becomes zero (time t₀), further pushing the object 80 causes the measured value of displacement to increase in the negative direction. The measured value of displacement changes in accordance with the amount of pushing.

An application that uses the composite sensor 10 can calculate a force applied to the composite sensor 10 based on the measured value of displacement output from the composite sensor 10.

Advantageous effects of the fifth example embodiment will now be described

Even in the configuration of the fifth example embodiment in which the amount of displacement is determined based on the signal from the force sensor 40, it is possible to continuously transition from a state in which the measured value of the distance L by the optical proximity sensor 20 changes over time to a state in which the measured value of displacement by the force sensor 40 changes over time, or vice versa. Additionally, an application can calculate a force applied to the force sensor 40 based on the measured value of displacement output from the composite sensor 10.

The example embodiments described above are examples, and some of the configurations described in different example embodiments can be replaced or combined. Similar advantageous effects achieved by the same or similar configurations of different example embodiments will not be described in each example embodiment. The present invention is not limited to the example embodiments described above. For example, it will be obvious to those skilled in the art that various changes, modification, and combinations are possible.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A composite sensor comprising:
a substrate including a first surface and a second surface facing in opposite directions;
an optical proximity sensor including a first light emitter and a first light receiver on the first surface of the substrate to output a signal dependent on a distance to an object by receiving, at the first light receiver, light emitted from the first light emitter and reflected by the object; and
a force sensor on the second surface of the substrate to output a signal dependent on a component of force perpendicular or substantially perpendicular to the substrate.

2. The composite sensor according to claim 1, wherein the force sensor includes a second light emitter, a second light receiver, an elastic portion, and a reflector whose position relative to the second light emitter and the second light receiver is changed by elastic deformation of the elastic portion, and is configured to measure the change in the position of the reflector by receiving, at the second light receiver, light emitted from the second light emitter and reflected by the reflector.

3. The composite sensor according to claim 2, wherein, in plan view of the second surface of the substrate, the elastic portion is located around the second light emitter and the second light receiver.

4. The composite sensor according to claim 2, wherein, in plan view of the first surface of the substrate, a minimum enclosing circle including the first light emitter and the first light receiver of the optical proximity sensor and a minimum enclosing circle including the second light emitter and the second light receiver of the force sensor include an overlapping portion.

5. The composite sensor according to claim 1, wherein, when the composite sensor is mounted on a device while a surface of the force sensor facing in a same direction as the second surface is in contact with a housing of the device and the composite sensor is used while a surface of the optical proximity sensor facing in a same direction as the first surface is in contact with a cover transparent in a wavelength region of light emitted from the first light emitter, a force applied to the cover is transmitted to the housing via the optical proximity sensor, the substrate, and the force sensor.

6. The composite sensor according to claim 2, further comprising a processor configured or programmed to acquire the signal from the optical proximity sensor and the signal from the force sensor in a synchronized manner.

7. The composite sensor according to claim 6, wherein the processor is configured or programmed to output data based on the signal from the optical proximity sensor and data based on the signal from the force sensor in association with each other, the signals being acquired in a synchronized manner.

8. The composite sensor according to claim 6, wherein the processor is shared by the optical proximity sensor and the force sensor, and configured or programmed to alternately operate the optical proximity sensor and the force sensor to alternately acquire the signal from the optical proximity sensor and the signal from the force sensor.

9. The composite sensor according to claim 6, wherein the processor is configured or programmed to calculate the distance to the object based on the signal from the optical proximity sensor, and calculate the force based on the signal from the force sensor.

10. The composite sensor according to claim 9, wherein the processor is configured or programmed to be calibrated so that, when the object gradually approaches the optical proximity sensor and a result of calculation of the distance based on the signal from the optical proximity sensor becomes zero, a result of calculation of the force based on the signal from the force sensor rises.

11. The composite sensor according to claim 1, wherein the substrate includes a multilayer wiring board.

12. The composite sensor according to claim 11, wherein the multilayer wiring board includes a printed wiring board or a low-temperature co-fired ceramic board.

13. The composite sensor according to claim 1, wherein the force sensor includes a piezoelectric force sensor, an optical force sensor, or an electrostatic-capacitive force sensor.

14. The composite sensor according to claim 1, wherein the first light emitter includes a light-emitting diode or a vertical-cavity surface-emitting laser.

15. The composite sensor according to claim 1, wherein the first light receiver includes a photodiode, a phototransistor, or a CdS cell.

16. The composite sensor according to claim 5, wherein a spacer is interposed between the cover and the substrate.

17. The composite sensor according to claim 2, wherein the second light emitter includes a light-emitting diode or a vertical-cavity surface-emitting laser.

18. The composite sensor according to claim 2, wherein the second light receiver includes a photodiode, a phototransistor, or a CdS cell.

19. The composite sensor according to claim 2, wherein the elastic portion has a Young's modulus of less than about 1000 MPa.
